(19) United States
(12) Patent Application Publication
(10) Pub. No.: US 2008/0079779 A1
(43) Pub. Date: Apr. 3, 2008

(54) Method for Improving Thermal Conductivity in Micro-Fluid Ejection Heads

(76) Inventors: Robert Lee Cornell, Lexington, KY (US); Robert Wilson Cornell, Lexington, KY (US); Curtis Ray Droege, Richmond, KY (US); Elios Klemo, Lexington, KY (US); Timothy Lowell Strunk, Georgetown, KY (US); Melissa Marie Waldeck, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/536,438

(22) Filed: Sep. 28, 2006

(51) Int. Cl. B41J 2/06

(52) U.S. Cl. 347/55

(57) ABSTRACT

Methods for improving the thermal conductivity of a substrate for a micro-fluid ejection head and micro-fluid ejection heads are provided. One such head includes a substrate having a thermal conductivity ranging from about 1.4 W/m-° C. to about 148 W/m-° C., a fluid ejection actuator, and a thermal bus thermally adjacent to the substrate and configured to dissipate heat associated with the operation of the actuator. Exemplary modified substrates have improved thermal conductivity characteristics as compared to a corresponding substrate not modified to include the thermal bus.

### FIELD OF THE DISCLOSURE

The present disclosure is generally directed toward methods for improving the thermal conductivity of micro-fluid ejection heads. More particularly, in an exemplary embodiment, the disclosure relates to improvements in the manufacture of micro-fluid ejection heads utilizing alternative substrate materials.

### BACKGROUND AND SUMMARY

Multi-layer circuit devices such as those used in the manufacture of micro-fluid ejection heads have a plurality of electrically conductive layers separated by insulating dielectric layers and applied adjacent to a substrate. Thermal energy generators or heating elements, usually resistors, are located on a surface of the substrate to heat and vaporize the fluid to be ejected.

Conventionally, the substrate material has been made substantially of alumina (in the case of devices utilizing silicon chip attachments) or silicon (in the case of traditional thermal micro-fluid ejection heads), typically circular single crystalline silicon wafers. Alumina, and especially silicon, have favorable thermal conductivities which enable heat to be rapidly dissipated from a region of the substrate adjacent to the thermal energy generators. However, the use of silicon substrates has proved unsuitable in achieving micro-fluid ejection heads, such as ink jet devices, having a relatively wide swath ejection head. This is due to the fragility of such substrates, especially as their dimensions are increased. Meanwhile, alumina is not traditionally used in thermal micro-fluid ejection heads because of a need for very smooth substrate surfaces (which are required for thin-film processing and correct heating element characteristics).

It has been discovered that substrates for providing micro-fluid ejection heads having a relatively wide swath may be made by using materials such as low temperature co-fired ceramic (LTCC) and glass for the substrate material (LTCC is a glass/ceramic material). However, such substrate materials have relatively low thermal conductivities and are unable to effectively dissipate heat, especially if a thermal ejection head is operated at high fluid ejection frequency. The inability to effectively dissipate heat can undesirably affect performance of the micro-fluid ejection head. For example, a fluid entering the thermal ejector region after a fluid ejection phase may prematurely boil due to the residual high temperature in the thermal ejector region. Effective heat dissipation immediately after a fluid ejection phase avoids such conditions.

The exemplary embodiments disclosed herein advantageously provide for modification of substrates, especially relatively low thermal conductivity substrates such as those made from LTCC and glass, so that the resulting heads may effectively dissipate heat, for example. In one aspect, the exemplary embodiments advantageously enable the production of relatively wide swath micro-fluid ejection heads using substrate materials of relatively low thermal conductivity, especially ceramic substrates, glass substrates and glass/ceramic substrates.

Another of the disclosed exemplary embodiments relates to methods for improving the thermal conductivity of substrates and to the heads provided thereby.

One such head has a substrate with a thermal conductivity ranging from about 1.4 W/m-° C. to about 148 W/m-° C., a fluid ejection actuator, and a thermal bus thermally adjacent to the substrate and configured to dissipate heat associated with the operation of the actuator. In an exemplary embodiment, the modified head has improved thermal conductivity characteristics as compared to a corresponding head not modified to include the thermal bus.

### BRIEF DESCRIPTION OF THE DRAWINGS

Further advantages of exemplary embodiments disclosed herein may become apparent by reference to the detailed description of exemplary embodiments when considered in conjunction with the drawings, which are not to scale, wherein like reference characters designate like or similar elements throughout the several drawings as follows:

FIG. 1 is a schematic plan view showing a substrate modified according to an exemplary embodiment.

FIG. 2 is a schematic side view of the substrate of FIG. 1.

FIG. 3 is a graph showing the thermal profile of a conventional micro-fluid ejection head having a silicon substrate.

FIG. 4 is a graph showing the thermal profile of a conventional micro-fluid ejection head having an alumina substrate.

FIG. 5 is a graph showing the thermal profile of a micro-fluid ejection head having a conventional low temperature co-fired ceramic (LTCC) substrate not having been modified as disclosed herein.

FIG. 6 is a graph showing the thermal profile of a micro-fluid ejection head having a low temperature co-fired ceramic (LTCC) substrate modified according to a disclosed exemplary embodiment.

FIG. 7 is a graph showing the thermal profile of a micro-fluid ejection head having a conventional glass substrate not having been modified as disclosed herein.

FIG. 8 is a schematic partial side view showing a low temperature co-fired ceramic (LTCC) substrate modified according to a disclosed exemplary embodiment.

FIG. 9 is a representational side view of a micro-fluid ejection head according to a disclosed exemplary embodiment.

FIG. 10 is a graph showing firing frequency as a function of thermal barrier thickness for a micro-fluid ejection head having a low temperature co-fired ceramic (LTCC) substrate modified according to a disclosed exemplary embodiment.

FIG. 11 is a graph showing firing frequency as a function of thermal barrier thickness for a micro-fluid ejection head having a glass substrate modified according to a disclosed exemplary embodiment.

### DETAILED DESCRIPTION OF EXEMPLARY EMBODIMENTS

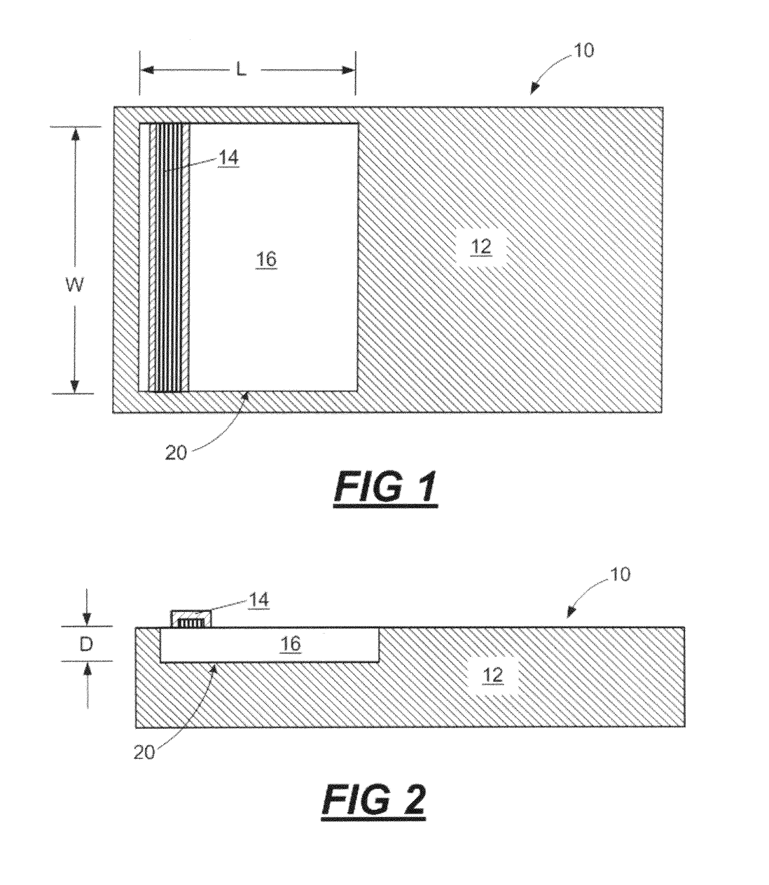

According to exemplary embodiments disclosed herein, there is provided methods for modifying low thermal conductivity substrates to yield substrates having improved thermal conductivity properties. With reference to FIG. 1, there is shown a plan view of a portion of a micro-fluid ejection head 10, such as an inkjet printhead, having a substrate 12 modified according to such an exemplary embodiment.

In a manner well known in the art, thermal fluid ejection actuators, such as heater resistors, are formed adjacent to a device surface of the modified substrate 12 in an actuator region 14 of the substrate 12. Upon activation of a thermal fluid ejection actuator in the actuator region 14, fluid supplied through a fluid path(s) in an associated fluid reservoir and corresponding fluid flow slot(s) in the substrate 12 is caused to be ejected toward a media through a nozzle in a nozzle plate associated with the substrate 12.

Substrate 12 represents a base substrate material which has been modified by adding a thermal bus 16 including a thermally conductive material 18. The thermal bus 16 is configured to dissipate heat associated with the operation of the ejection actuators and improve the overall thermal conductivity of the head 10 as compared to a corresponding head devoid of the thermal bus 16.

The base material used to provide the substrate 12 may be selected from materials having a thermal conductivity ranging from the thermal conductivity of glass (1.4 W/m-° C.) to a thermal conductivity less than that of silicon (148 W/m-° C.), and in some embodiments, also less than the thermal conductivity of alumina (30 W/m-° C.). For example, suitable materials include glass and ceramic substrates, such as, low temperature co-fired ceramic (LTCC) substrates which have a thermal conductivity generally in the range of from about 2 to about 4 W/m-° C.

For example, suitable substrates have a thermal conductivity ranging from about 1.4 W/m-° C. to about 148 W/m-° C., in some cases desireably from about 1.4 W/m-° C. to about 30 W/m-° C., and, in some cases, more desirably from about 1.4 W/m-° C. to about 4 W/m-° C.

The thermal bus 16 may be provided for by forming one or more trenches 20 in the substrate 12, such as by a variety of methods including, laser, diamond saw, abrasive water jet, water-laser-jet, sandblasting, and the like. The trench may also be formed by, for example, stacking pre-punched layers of LTCC in such a way as to form the trench for the thermal bus. Next, the thermally conductive material 18, such as metal may be introduced into the trenches 20.

The trenches 20 for the thermal bus 16 may run substantially the length of the actuator region 14, and may be located under the actuator region 14. Although not necessarily preferred, it is functionally possible to have a thin layer separating the actuator from the thermal bus, depending on the heat dissipation requirements. The application of the thermally conductive material 18 may be accomplished as by depositing the thermally conductive material 18 in each trench 20 by screen printing, plating, or spray deposition. With screen printing and spray deposition, the deposited metal or other material 18 may be heated such as to drive off solvents and other volatiles. The thermally conductive trenches may also be provided as by the so-called Damascene metallization process. If the thermally conductive material 18 is screen printed or spray deposited, the deposited material may sit flush or just under flush to the top edge of the trench 20. If the deposited material 18 sits above the edge of the trench 20, it may be ground, polished, or otherwise removed until it is flush with the trench 20.

Materials suitable for use as the thermally conductive material 18 may include materials having a thermal conductivity of at least about 200 W/m-° C. Particularly suitable materials may include metals such as silver (thermal conductivity ranging from about 406 to about 429 W/m-° C.) and copper (thermal conductivity ranging from about 385 to about 429 W/m-° C.) and mixtures thereof. The trenches 20 (and hence the material 18 therein) may have a thickness or depth (D) of, for example, at least about 40 μm, a length (L) of, for example, at least about 150 μm, and a width (W) of, for example, at least substantially corresponding to a length of the actuator region 14 (typically greater than about 25 millimeters).

In addition to providing heat dissipation properties it has also been observed that the thermal bus 16 may function as an embedded power/ground bus. For example, to maintain the electrical isolation properties of the substrate 12, a material with high thermal and electrical insulation properties may be deposited between the trench and the actuator region 14. Materials that are appropriate for this layer may include, glass borophosphosilicate glass (BPSG), spin-on-glass (SOG), and the like. In constructing the thermal/electrical insulation layer, it may be necessary to bring it up to a suitable reflow temperature. In this regard, the melting temperature of the metal or other thermally conductive material 18 in the trench 20 may be above that of the reflow temperature of the electrical/thermal insulation material.

The thermal bus 16 may alternatively be provided as a blanket of the thermally conductive material 18 deposited as a layer adjacent to substantially the whole of the substrate 12. This embodiment advantageously facilitates any subsequent polishing steps.

Modification of relatively low thermal conductivity substrates 12 in accordance with the disclosed exemplary embodiments are believed to improve heat dissipation properties. Furthermore, it is believed that such modified substrates should have heat dissipation characteristics so as to be usable in place of conventional substrates made of silicon and alumina for micro-fluid ejection applications such as inkjet printheads.

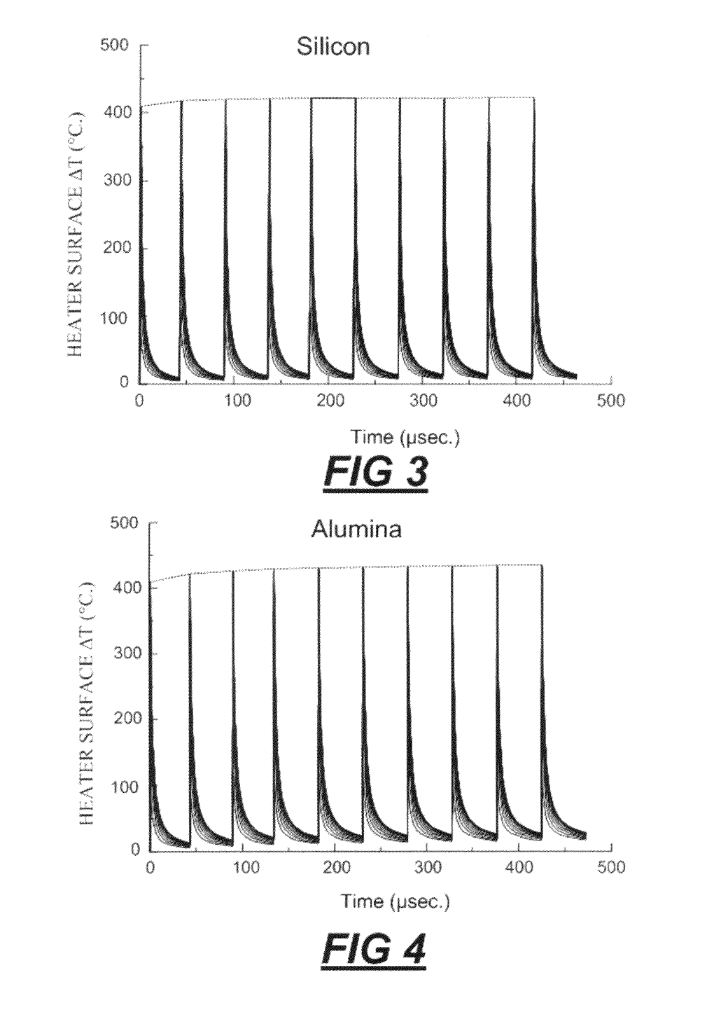

For example, with reference to FIGS. 3 and 4, there are shown graphs of the modeled thermal profile of conventional micro-fluid ejection heads having conventional silicon and alumina substrates, respectively, through ten simultaneous firing sequences.

As will be noted, the head having the silicon substrate (FIG. 3) dissipated heat between fires into the substrate a sufficient amount, as represented by the relatively low temperature increases of the substrates between firing cycles. In the case of a silicon substrate a decrease in time between successive nucleation of fluid after 10 ejection cycles is about 24 nanoseconds with an overall temperature increase at the end of 10 cycles of about 13° C. Note that by 10 cycles the temperature rise stabilizes at about 13° C. That is, at the end of the 10 cycles, the ink-heater interface is about 13° C. hotter than when the firing cycles began. This temperature increase gives subsequent cycles a 24 nanosecond head start on reaching the ink's nucleation temperature. This has been observed to represent a relatively small percentage of the nucleation onset time (about 600 nanoseconds). Thus no intra-fire pulse timing changes should need to be made as a result of the fire history of the ejector. That is to say that 24 nanoseconds is at or below the granularity of the pulse timing system.

In FIG. 4, the modeled alumina substrate head had an overall temperature increase at the end of 10 cycles of about 24° C., corresponding to a decrease in nucleation onset of about 50 nanoseconds. In other words, because the ink-heater interface has a 24° C. head start towards the ink's nucleation temperature, the onset of nucleation is decreased by about 50 nanoseconds. This level has also been observed to be acceptable for micro-fluid ejection purposes.

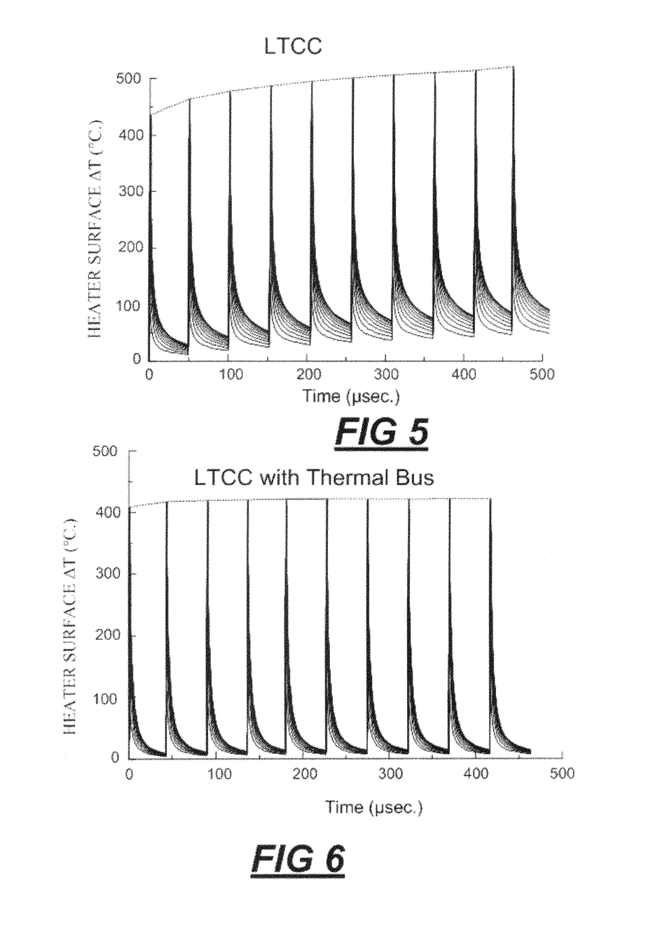

FIG. 5 shows the modeled thermal profile of a micro-fluid ejection head having a conventional low temperature co-fired ceramic (LTCC) substrate. In comparison, FIG. 6 shows the modeled thermal profile of a micro-fluid ejection head having a low temperature co-fired ceramic (LTCC) substrate modified according to the disclosed exemplary embodiments. As will be seen, the unmodified LTCC substrate is unable to effectively dissipate heat, having an overall temperature increase at the end of 10 cycles of about 80° C., corresponding to a decrease in the nucleation onset of about 165 nanoseconds. This level is believed to be unacceptable for micro-fluid ejection purposes.

To the contrary, the LTCC substrate modified in accordance with the disclosed exemplary embodiments has a modeled thermal profile which closely resembles that of the silicon substrate illustrated in FIG. 3 and is believed to be able to effectively dissipate heat. For example, the modified substrate had an overall temperature increase at the end of 10 cycles of about 12° C., corresponding to a decrease in nucleation onset of about 24 nanoseconds, which is substantially the same as that observed for the silicon substrate.

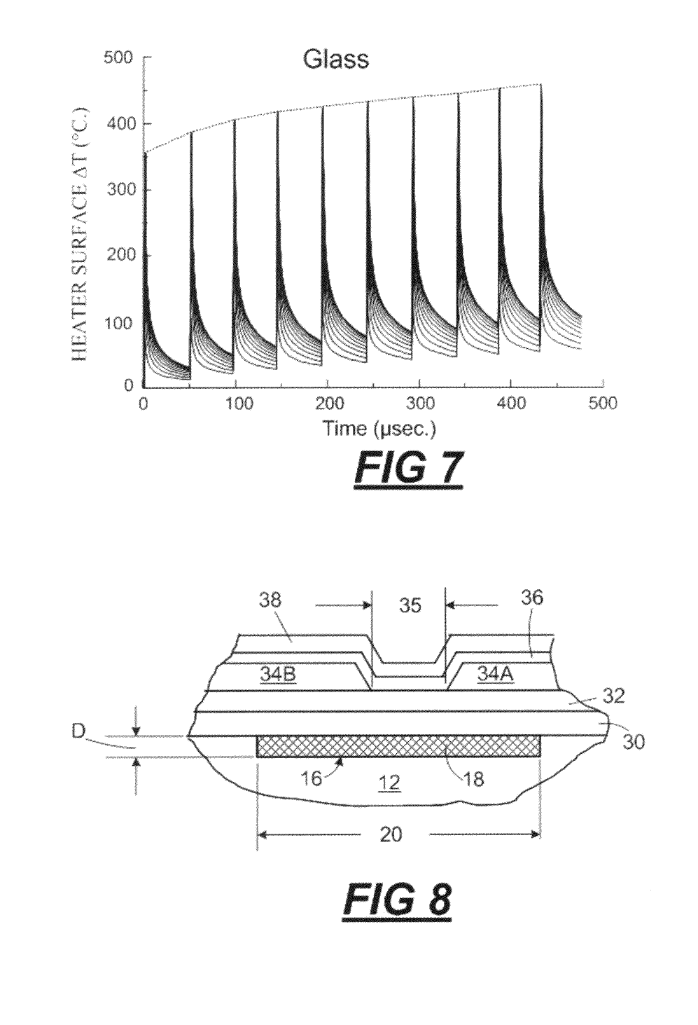

FIG. 7 shows the modeled thermal profile of a micro-fluid ejection head having a conventional glass substrate. As shown by the graph glass is unable to effectively dissipate heat, having an overall temperature increase at the end of 10 cycles of about 120° C., corresponding to a decrease in the nucleation onset of about 250 nanoseconds. Improvements similar to that observed for modified LTCC substrates were observed for glass substrates modified in accordance with the disclosed exemplary embodiments to include a thermal bus 16.

The micro-fluid ejection heads modeled in the temperature profiles of FIGS. 3-7 were each presumed to be made in the same manner, except for the composition of the substrate. FIG. 8 shows a portion of the basic micro-fluid ejection head 10 wherein electrically conductive layers separated by insulating dielectric layers are applied adjacent to the substrate 12. The substrate 12 depicted is a LTTC substrate modified to include the thermal bus 16 provided by depositing silver 20 (50 μm) in the trench 20 (FIGS. 1 and 2). The following layers may be applied to the substrate 12 to provide the thermal fluid ejection actuator/ejection head structure:

| Layer | Composition |
|---|---|
| 30 | 2 μm SiO2, or BPSG |
| 32 | 0.5 to 1 μm TaN, or TaAl, or TaAlN |
| 34a & 34b | 0.4 to 0.6 μm Al, or AlCu, anode |
| | and cathode conductors configured to |
| | define a thermal fluid ejection |
| | actuator 35 |
| 36 | 0.25 μm Si₃N₄ |
| 38 | 0.2 μm Ta |

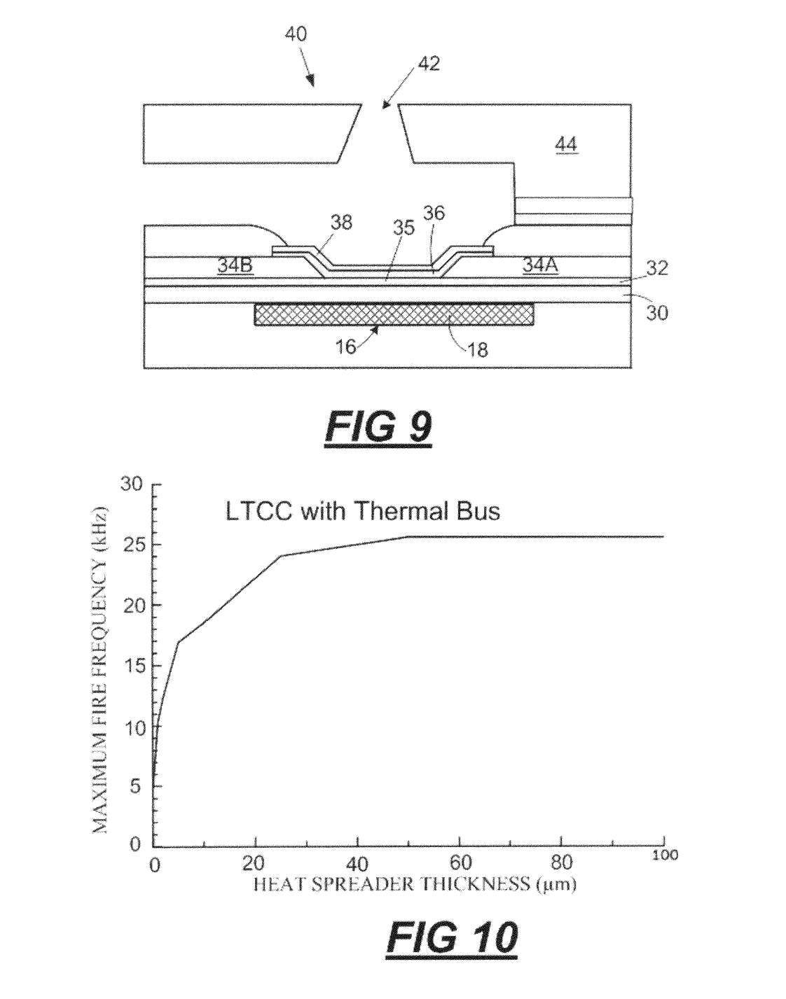

The structures associated with the graphs for FIGS. 3, 4, 5 and 7 may be made in the same manner, but were modeled assuming the substrates were made of silicon, alumina, and LTCC, which were not modified to include the thermal bus 16. FIG. 9 depicts a portion of a thermal ejection head 40 incorporating the substrate 12 having the thermal bus 16, according to the disclosed exemplary embodiments, for ejecting fluid through a nozzle 42 of an associated nozzle plate 44.

To provide the results depicted in the graphs of FIGS. 3-7, 10 firing cycles were modeled as shown with the thermal fluid ejection actuators being energized (0.7 μJ delivered in 1 μs) having a dimension of 32.6 μm×10.8 μm and a heater-heater pitch of 42.2 μm (600 per inch).

FIG. 10 is a graph showing the effect of the thickness of the thermal bus 16 as a function of firing frequency for the LTCC substrate of FIGS. 6, 8 and 9. As will be observed, results improved dramatically from a thickness over about 20 μm, with no significant improvements gained above about 50 μm. That is, no appreciable increase in the maximum firing frequency was observed from greater thicknesses. Accordingly, an exemplary thickness of the thermal bus 16 is about 50 μm. Similar results were obtained for glass substrates.

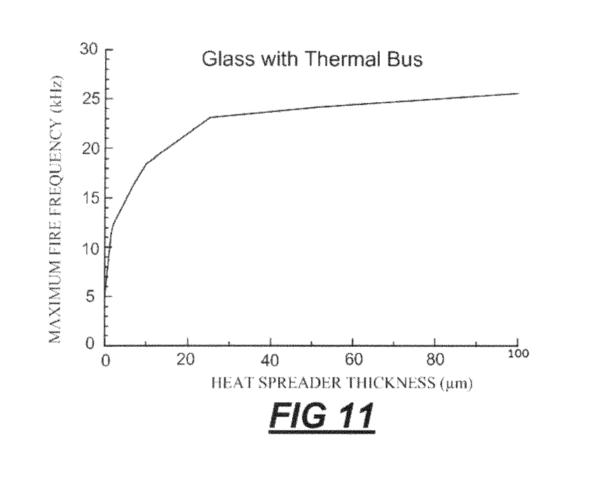

FIG. 11 is a graph showing the effect of the thickness of the thermal bus 16 as a function of firing frequency for a glass substrate modified according to the disclosed exemplary embodiments to include a thermal bus 16. As will be observed, modification of the glass substrate to include a thermal bus 16 of at least 20 microns thick enabled a firing frequency of 20 kHz and above.

It is contemplated, and will be apparent to those skilled in the art from the preceding description and the accompanying drawings that modifications and/or changes may be made in the embodiments of the disclosure. Accordingly, it is expressly intended that the foregoing description and the accompanying drawings are illustrative of exemplary embodiments only, not limiting thereto, and that the true spirit and scope of the present invention(s) be determined by reference to the appended claims.

1. A micro-fluid ejection head comprising: a substrate having a thermal conductivity ranging from about 1.4 W/m-° C. to about 148 W/m-° C., a thermal fluid ejection actuator, and a thermal bus thermally adjacent to the substrate and configured to dissipate heat associated with the operation of the actuator.

2. The head of claim 1, wherein the thermal bus also functions as an electrical bus of the head.

3. The head of claim 1, wherein the substrate has a thermal conductivity of from about 1.4 W/m-° C. to about 4 W/m-° C.

4. The head of claim 1, wherein the substrate is selected from the group consisting of glass substrates, ceramic substrates, and ceramic/glass substrates.

5. The head of claim 1, wherein the thermal bus comprises a trench containing a thermally conductive material underlying a fluid ejection actuator region.

6. The head of claim 5, wherein the thermally conductive material has a thickness of at least about 20 microns.

7. The head of claim 6, wherein the thermally conductive material has a thermal conductivity of at least about 200 W/m-° C.

8. The head of claim 1, wherein the thermal bus comprises a thermally conductive material substantially adjacent to a device surface of the substrate.

9. A method for improving the thermal conductivity of a substrate for a micro-fluid ejection head, the method comprising:
applying thermally conductive material in a trench in a fluid ejection actuator region of a substrate having a thermal conductivity ranging from about 1.4 W/m-° C. to about 148 W/m-° C.; and
forming a thermal fluid ejection actuator thermally adjacent to the thermally conductive material in the trench.

10. The method of claim 9, wherein the actuator comprises a resistor.

11. The method of claim 9, wherein the substrate has a thermal conductivity of from about 1.4 W/m-° C. to about 4 W/m-° C.

12. The method of claim 9, wherein the substrate is selected from the group consisting of glass substrates, ceramic substrates, and ceramic/glass substrates.

13. The method of claim 9, wherein the thermally conductive material has a thickness of at least about 20 microns.

14. The method of claim 9, wherein the thermally conductive material has a thermal conductivity of at least about 200 W/m-° C.

15. A micro-fluid ejection head, comprising:
a substrate having a thermal conductivity ranging from about 1.4 W/m-° C. to about 148 W/m-° C.;
a thermal fluid ejection actuator;
a nozzle adjacent to the fluid ejection actuator for passage of ejected fluid; and
a thermal bus thermally adjacent to the substrate and configured to dissipate heat associated with the operation of the actuator.

16. The head of claim 15, wherein the thermal bus also functions as an electrical bus of the head.

17. The head of claim 15, wherein the substrate has a thermal conductivity of from about 1.4 W/m-° C. to about 4 W/m-° C.

18. The head of claim 15, wherein the substrate is selected from the group consisting of glass substrates, ceramic substrates and glass/ceramic substrates.

19. The head of claim 15, wherein the thermal bus comprises a trench containing a thermally conductive material underlying a fluid ejection actuator region.

20. The head of claim 15, wherein the thermal bus comprises a thermally conductive material substantially adjacent to a device surface of the substrate material.
